(19) United States
(12) Patent Application Publication
(10) Pub. No.: US 2021/0398153 A1
(43) Pub. Date: Dec. 23, 2021

(54) Dynamic Platform For Physical Stores Information For Interactive Map

(71) Applicant: Google LLC, Mountain View, CA (US)

(72) Inventors: Matthew Sharifi, Kilchberg (CH); Victor Carbune, Zurich (CH)

(73) Assignee: Google LLC, Mountain View, CA (US)

(21) Appl. No.: 16/981,424

(22) PCT Filed: Jun. 23, 2020
(86) PCT No.: PCT/US2020/039065

§ 371 Date: Sep. 16, 2020

(51) Int. Cl. G06Q 30/02; G06N 20/00; G06N 5/04; G06F 16/29

(52) U.S. Cl. CPC G06Q 30/0205; G06Q 30/0259; G06Q 30/0273; G06F 16/29; G06N 20/00; G06N 5/04; G06Q 30/0256

(57) ABSTRACT

A dynamic platform in a map application allows users to discover various types of goods at a selected geographic region. A method for utilizing the dynamic platform includes providing, by one or more processors, a map for display on a computing device. The method includes receiving, by the one or more processors, a request for displaying a business content in the map, wherein the business content includes information in relation to physical stores. The method includes displaying, by the one or more processors, the business content at a selected geographic location. The method includes collecting, by the one or more processors, computational data of local market information related to the selected geographic location. The method includes presenting, by the one or more processors, the local market information in the map. The method includes providing a recommendation whether to update the business content based on the local market information.

### BACKGROUND

Digital maps are widely used to provide information related to geographical regions of interest, including information about roads, traffic, buildings, landmarks, commercial information, shopping guidance, retail or grocery stores and the like. Interactive maps often allow a user, for example, to access the digital map of a selected region of interest to search for activities or attributes around surrounding locations. However, over recent years, brick and mortar stores have become increasingly dynamic in terms of layout, styles or ownership. Frequent change of layout, ownership or styles of these dynamic stores can result in inaccurate information appearing in the digital maps. Some digital maps are not configured to reflect instant changes of these dynamic stores. Such inaccurate information in the digital map often creates difficulty for retail or business owners that are looking for a physical space for their business to find proper locations or properties. Such inaccurate information in the digital map contributes to inconsistencies and incongruities in the content of the digital map. These inconsistencies and incongruities may cause technical malfunctions in the map application and/or interfere with the provision of an effective human-computer interaction. Such inaccurate information can also fail to inform customers searching for a particular type of business in a particular location. Furthermore, such inaccurate information is problematic for service/property providers, who want to publish the most updated available properties/spaces with dynamically changing layouts, styles, ownership or sub-divided features to retail or business owners.

### BRIEF SUMMARY

One aspect of the disclosure provides a dynamic platform in a map application that allows users, customers, advertisers, business owners, property managers and the like to discover various types of goods at a selected geographic region of interest. In one aspect, a method for utilizing the dynamic platform is provided. The method includes providing a map for display on a computing device. One or more processors is configured to provide the map. The method includes receiving, by the one or more processors, a request for displaying a business content in the map, wherein the business content comprises information in relation to physical stores available for business activities. The method also includes displaying, by the one or more processors, the business content at a selected geographic location in the map. The method also includes collecting, by the one or more processors, computational data of local market information related to the selected geographic location. The method also includes presenting, by the one or more processors, the local market information in the map. The method also includes providing, by the one or more processors, a recommendation whether to update the business content based on the local market information.

In some implementations, the method includes receiving, by the one or more processors, a bid. The bid may be in response to the recommendation. In some implementations, the method includes accepting or declining, by the one or more processors, the bid. In some implementations, the method includes updating, by the one or more processors, the business content in the selected geographic location in the digital map. The update may be performed in response to the acceptance of a bid. Accordingly, by updating the business content in the digital map, the method ensures that the information provided in the digital map is accurate and up to date, thereby eliminating any risk for inconsistencies or incongruencies in the information provided. As a result, technical malfunctions are avoided. In addition, the user may place, or accept or decline, bids from within the map application, removing the need to perform such tasks in a separate window or via a separate application. An improved human-machine interaction is therefore provided.

In some implementations, the method also includes utilizing a machine learning technique to provide dynamic information related to the location market information. In some implementations, the method also includes utilizing a learned ranking model to integrate the computational data to provide the location market information related to the selected geographic location. In some implementations, the method also includes outputting a recommendation score by the learned ranking model. In some implementations, the recommendation score suggests whether to place a bid in response to the business content. In some implementations, the computational data comprises user' s navigation data, searches or direction requests collected from the selected geographic location in the map.

In some implementations, the method also includes generating, by the one or more processors, commercial update or notifications in the digital map. In some implementations, the business content comprises an interior layout, a style, an ownership change of a space in the target geographic location. In some implementations, the business content is listed by a property provider.

Another aspect of the disclosure provides a computing device. The computing device includes one or more memories, and one or more processors in communication with the one or more memories, the one or more processors configured to provide, by one or more processors, a map for display on a computing device. The computing device also receives, by the one or more processors, a request for displaying a business content in the map, wherein the business content comprises information in relation to physical stores available for business activities. The computing device also displays, by the one or more processors, the business content at a selected geographic location in the map. The computing device also collects, by the one or more processors, computational data of local market information related to the selected geographic location. The computing device also presents, by the one or more processors, the local market information in the map. The computing device also provides, by the one or more processors, a recommendation whether to update the business content based on the local market information

In some implementations, the computing device also places, by the one or more processors, a bid. The bid may be in response to the recommendation in the map. In some implementations, the computing device also accepts or declines, by the one or more processors, the bid. In some implementations, the computing device also updates, by the one or more processors, the business content in the selected geographic location. The update may be performed in response to the acceptance of a bid. Accordingly, by updating the business content in the digital map, the computing device ensures that the information provided in the digital map is accurate and up to date, thereby eliminating any risk for inconsistencies or incongruencies in the information provided. As a result, technical malfunctions of the computing device are avoided. In addition, the user may place, or accept or decline, bids from within the map application, removing the need to perform such tasks in a separate window or via a separate application. An improved human-machine interaction is therefore provided.

In some implementations, the computing device also includes a machine learning technique utilized to provide dynamic information related to the location market information. In some implementations, the computing device also includes a learned ranking model is utilized to integrate the computational data to provide the location market information related to the selected geographic location. The learned ranking model outputs a recommendation score. The recommendation score suggests whether to place a bid in response to the business content.

Another aspect of the disclosure provides a computer-readable storage medium comprising executable computer instructions for performing operations including receiving a business content from a service provider in a dynamic platform in a map provided by a computing device, wherein the business content comprises information in relation to physical stores available for business activities. The operations also include displaying the business content at a selected geographic location in the digital map in the computing device. The operations also include inputting queries by a user. In some implementations, the operations also include interactively adjusting the business content by the service provider based on the queries input by the user.

In some implementations, the operations also include outputting a recommendation score to the user based on the queries provided by the user.

### BRIEF DESCRIPTION OF THE DRAWINGS

FIG. 1 is a block diagram of an example computing device according to aspects of the disclosure.

FIG. 2 is a block diagram of example communications of a dynamic platform according to aspects of the disclosure.

FIG. 3A-3B are digital maps zoomed in at a region of interest with business contents provided through the dynamic platform according to aspects of the disclosure.

FIG. 4 is a street view of a digital map with business contents provided through the dynamic platform according to aspects of the disclosure.

FIG. 5 is an example of an interior layout of a physical space corresponding to the business content according to the example of FIG. 4.

FIG. 6 is an example menu of input criteria for the business content according to the example of FIG. 4.

FIG. 7A-7D are different examples of commercial notifications or updates according to aspects of the disclosure.

FIG. 8 is a flow-diagram illustrating an example method of performing a communication of a business activity in the dynamic platform of FIG. 2 according to aspects of the disclosure.

FIG. 9 is a flow-diagram illustrating an example method of performing a business activity in the dynamic platform of FIG. 2 according to aspects of the disclosure.

### DETAILED DESCRIPTION

The present disclosure provides a dynamic platform utilizing a map application as an interface that allows a plurality of service providers or property providers to provide products, physical stores or services, such as on-demand service, in response to a plurality of requests. In some examples, the service providers may be advertisers, property managers, property owners and the like, who may provide various types goods, stores, or services to service requesters, such as business owners, vendors, and the like, at a selected geographic region of interest. For example, a business content from a service provider is presented in the dynamic platform in a selected geographic location in a digital map. The service provider may be a property owner that has a physical storefront, such as a brick-and-mortar store, for rent or lease. After the business content is presented, one or more requests or queries provided from the service requester are then received by the dynamic platform based on the business content presented. The service provider may determine whether to respond to the service requester by adjusting its property types or service types based on the requests or queries. The service requester may place an offer to the business content. The offer may then be accepted by the service provider through the dynamic platform. Accordingly, the digital map provides a user interface that allows different participants with different supplies and demands to efficiently interact through the dynamic platform. The dynamic platform also provides real-time on-demand service information that allows the service requester to explore the inventories provided from the service providers. The service providers may also interact in real-time and adjust their services or product line to meet the requests from the service requesters. The commercial service and information may be dynamically updated or displayed in the digital map through the dynamic platform so that users, such as consumers, clients or customers, may discover the most up-to-date business activities or services in the selected geographic region of interest. Accordingly, by updating the business content in the digital map, the dynamic platform ensures that the information provided in the digital map is accurate and up to date, thereby eliminating any risk for inconsistencies or incongruencies in the information set. As a result, technical malfunctions are avoided. In addition, the user may place, or accept or decline, bids from within the map application interface, removing the need to perform such tasks in a separate window or via a separate user interface. An improved human-machine interaction is therefore provided. In some examples, the dynamic platform may also provide historical and/or future activities planned in the selected geographic region of interest that allow the users to plan their purchasing or business arrangement accordingly.

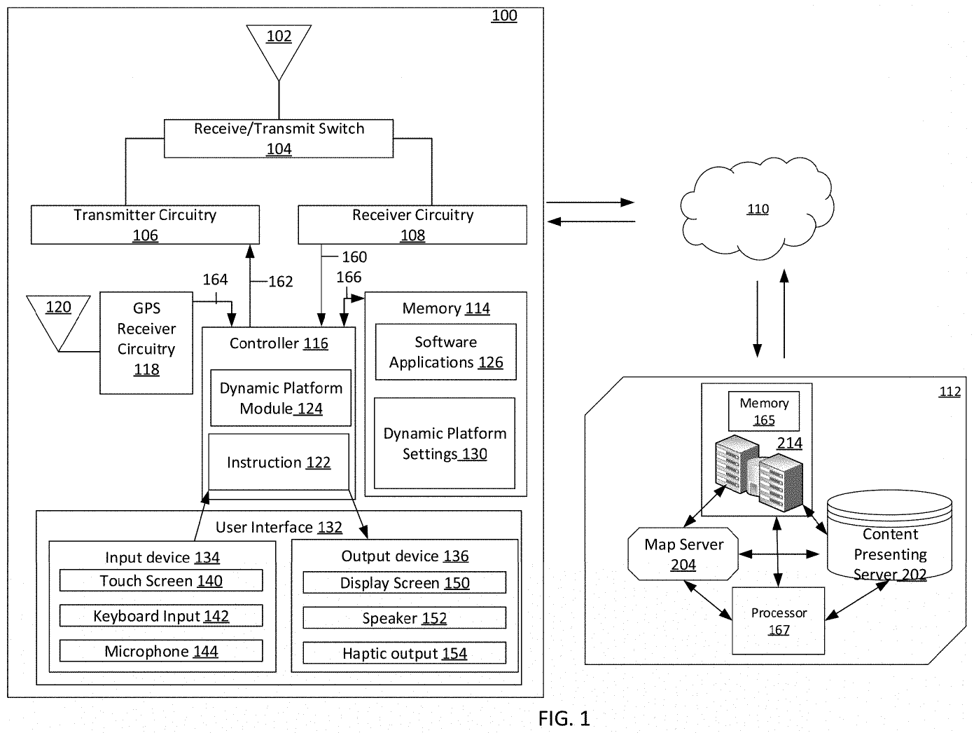

FIG. 1 depicts a detailed block diagram of an example computing device 100. The computing device 100 may be any device that can perform a computational operation. Suitable examples of the computing device 100 include desktop computers, laptop computers, PDA, personal computer, tablets, portable devices, such as smart phones, mobile phones, wearable devices and the like. In one example, the computing device 100 utilized herein is a smart phone. However, the computing device 100 described herein is not limited in this regard.

In one example, the computing device 100 has multiple components embedded therein. Each component may be in direct or indirect communication to each other. In the example depicted in FIG. 1, the computing device 100 includes one or more controllers 116 configured to be in electrical communication with a user interface 132, a memory 114, a GPS receiver circuitry 118, a transmitter circuitry 106 and a receiver circuitry 108. The one or more controller 116 can be any suitable processors, such as a microprocessor. Alternatively, the controller 116 can be dedicated components such as an application specific integrated circuit (“ASIC”) or other hardware-based processor. Although not necessary, one or more of computing devices 100 may include specialized hardware components to perform specific computing processes, such as dynamic platform execution, advertisement display and program, geographic coordination reading, street image recognition, GPS related searches and positioning, geographic location encoding, etc.

An antenna 102 may be disposed in the computing device 100 configured to receive and transmit Radio Frequency (RF) signals, WiFi signals, bluetooth signals, GPS signals or any suitable electrical signals. A receive/transmit (Rx/Tx) switch 104 selectively couples the antenna 102 to the transmitter circuitry 106 and receiver circuitry 108 as needed. The receiver circuitry 108 demodulates and decodes the electrical signals received from a network 110 to derive information therefrom. The network 110 may be further communicated with a database server 112 so as to provide information requested or inquired by the computing device 100. The network 110 provides connectivity between the computing device 100 and the database server 112. The network 110 may utilize standard communications protocols, such as internet, Ethernet, WiFi, satellite communications, HTTP and protocols that are proprietary to one or more companies, and various combinations of the foregoing. For example, the network 110 may be wired or wireless local area network (LAN), wide area network (WAN), cellular communication network as needed. The database server 112 may also be a computing device which also includes at least one processor, a receiver/transmitter, an interconnection interface and a memory that may store, send and/or generate information, data, software applications, map data, content, or interactive applications to the computing device 100. Thus, during operation, the database server 112 may execute operations including receiving requests from the computing device 100, such as a device that a user is interacting with, through the network 110. Subsequently, the database server 112 may then process, respond and provide the requested content, interaction, dynamic request, map data, or information through the network 110 to the computing device 100.

In one example, the receiver circuitry 108 is coupled to the controller 116 via an electrical connection 160. The receiver circuitry 108 provides the decoded electrical signals information to the controller 116. The controller 116 also provides information to the transmitter circuitry 106 for encoding and modulating information into electrical signals. Accordingly, the controller 116 is coupled to the transmitter circuitry 106 via an electrical connection 162. The transmitter circuitry 106 communicates the electrical signals to the antenna 102 for transmission to the database server 112 through the network 100.

In one example when the computing device 100 includes a GPS-enabled implementation, an antenna 120 is coupled to GPS receiver circuitry 118 for receiving GPS signals. The GPS receiver circuitry 118 demodulates and decodes the GPS signals to extract GPS location information therefrom. The GPS location information indicates the location of the computing device 100. The GPS receiver circuitry 118 provides the decoded GPS location information to the controller 116. As such, the GPS receiver circuitry 118 is coupled to the controller 116 via an electrical connection 164. It is noted that the present disclosure is not limited to GPS based methods for determining a location of the computing device 100. Other methods for determining a location of the computing device can be used herein as needed. It is noted that when a GPS receiver circuitry is not utilized or present in the computing device 100, the receive/transmit (Rx/Tx) switch 104 along with the a transmitter circuitry 106 and the receiver circuitry 108 may also function similar to the GPS receiver circuitry to provide the geographic information/location of the computing device 100 as needed.

In one example, the controller 116 stores the decoded electrical signal information and the decoded GPS location information in the memory 114 of the computing device 100. Accordingly, the memory 114 is connected to and accessible by the controller 116 through an electrical connection 166. The memory 114 of the computing device 100 may store information accessible by the one or more of the controllers 116 or processors, such as including instructions 122 that can be executed by the one or more controller 116. In one example, the memory 114 is a computer-readable storage medium comprising the instructions 112, which are executable computer instructions, for performing operations or commands input to the computing device 100. The memory 114 can also include applications 126 and dynamic platform settings 130, which are settings of operations and communications among different servers or modules and so on, that can be retrieved, manipulated, processed, executed, interacted or stored by the controller 116. In one example, the memory 114 may be a volatile memory and/or a non-volatile memory or any non-transitory type capable of storing information accessible by the controller/processor, such as a hard-drive, memory card, RAM, DVD, CD-ROM, a Dynamic Random Access Memory (DRAM), a Static Random Access Memory (SRAM), Read-Only Memory (ROM), flash memory, write-capable and read-only memories. The memory 114 can also have stored therein of software applications 126, for example, a map application, an advertising application that in communication with the map application, for implementing the methods of embodiments of the present disclosure including the dynamic platform settings 130 that may be utilized in the computing device 100.

Various implementations may be utilized to provide geographic location information and dynamic platform configurations to be written into memory 114. For example, a user may directly provide the location information or commercial presentation preference by direct input to a user interface 132 on the computing device 100. Similarly, other methods of establishing the position or configurations of the computing device 100 may be employed. The computing device 100 may be or may not be GPS-enabled or even include communication features such as provided by antenna 102, 120 and receive/transmit switch 104, although the example computing device 100 depicted in FIG. 1 would include these features.

In one example, the software applications 126 stored in the memory 114 may include, but are not limited to, software applications operative to perform the various methods, features and functions described herein. Furthermore, the dynamic platform settings 130 may also be configured or stored in the memory 114 that allow the user to repetitively use these settings for a user customized preference when interacting with a dynamic platform module 124 in the controller 116. For example, a user may formulate his/her customized commercial information or service presentation information to be saved in the memory 114. Accordingly, such information may be saved for repetitive uses when the service presentation is needed. It is noted that the dynamic platform settings 130 in the memory 114 may be in electrical communication with the dynamic platform module 124 configured in the controller 116, or referred as a processor, so as to enable the operation of the dynamic platform settings 130 being performed in the dynamic platform module 124 by the controller 116 when needed.

As depicted in FIG. 1, one or more sets of instructions 122 may be saved, completely or at least partially, within the controller 116 during execution thereof by the computing device 100. Alternatively, one or more of the instructions may be stored in the applications 126 or other modules in the memory 114. In this regard, the memory 114 and the controller 116 can constitute machine-readable media. The term “machine-readable media”, as used here, refers to a single non-transient medium or multiple non-transient media that store the one or more sets of instructions 122. The term “machine-readable media”, as used here, also refers to any medium configured to store, encode or carry the set of instructions 122 for execution by the computing device 100 and that cause the computing device 100 to perform one or more of the methodologies of the present disclosure.

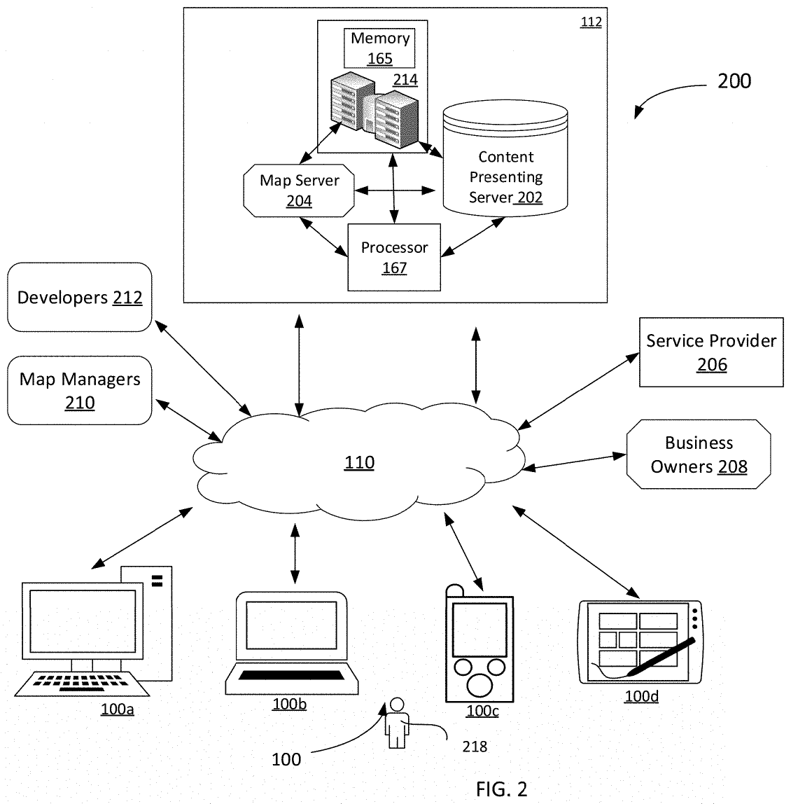

The dynamic platform module 124 is configured in the controller 116 that allows commercial activity/service to be operated in the computing device 100. In one example, the dynamic platform module 124 may provide a platform that allows multi-directional communications in the software applications 126, user input and/or from the database servers 112. In one example, the database servers 112 include at least a map server 204 and a content presenting server 202 in communication with a datacenter 214, which will be described in greater detail with reference to FIG. 2. The datacenter 214 may include a memory 165, similar to the memory 144, configured to store data and information, such as the digital map with street view, two-dimensional view, three-dimensional view, or the like. At least one processor 167, similar to the controller 116, may be utilized in the database servers 112 configured to execute command and instructions from the datacenter 214 and/or the memory 165.

The dynamic platform module 124 provides a platform that allows multiple parties or participants to provide, utilize, publish, list, submit, use, alter commercial services or other information in a selected geographic region in the digital map generated by the map application. The participants may input, request or accept requests or demands to or from the dynamic platform module 124 through a user interface 132, or through the database server 112 via the network 110. The dynamic platform module 124 enables efficient and instant communications about the changes and demands of commercial services or other information at a selected geographic region. Furthermore, custom preferences, options, settings or the like among different participants may also be instantly posted or listed in the commercial services or on the digital map through the dynamic platform module 124 so that an user can receive notifications or updates of the activities of a physical storefronts more instantly and accurately.

As illustrated in FIG. 1, components of the dynamic platform module 124 may be executed on the computing device 100. In some implementations, one or more components of the dynamic platform module 124 may be executed on the database server 112.

The controller 116 is also connected to the user interface 132. The user interface 132 includes input devices 134, output devices 136, and software routines or other user interface (not shown in FIG. 1) configured to allow a user to interact with and control applications 126 and the instruction 122 installed on the computing device 100. In one example, the applications 126 may, for example, provide for the use of other positioning technologies in addition to or instead of GPS, such as, but not limited to other satellite-based positioning systems or other techniques such as IP geolocation, or the like. Such input and output devices 134, 136 may respectively include, but are not limited to, a display screen 150, a speaker 152, a keypad 142, a microphone 144, a touch screen 140, a haptic output 154 and so on. It is noted that the display screen 150 and the touch screen 140 as described herein may referred to the same object to provide multiple functionalities. For example, the display screen 150 may not only display content but also provides a touch-activated interface, referred to as a touch screen 140, that allows the user to input command and to actively interact therewith. The input and output devices 134, 136 may include less, more, or different devices including a directional pad, a directional knob, accelerator, a Push-To-Talk (“PTT”) button, sensors, a camera, a Radio Frequency Identification (“RFID”)/Near Field Communication (“NFC”) reader, sound/audio recognition devices, motion detector, accelerometers, activity monitors, and the like.

FIG. 2 is a block diagram of an example of communications of a dynamic platform 200 according to aspects of the disclosure. A service provider 206, a business owner 208, a map manager 210 or a property developer 212 may access the database server 112 via the network 110. It is noted that, in one example, the service provider 206 described herein may provide buildings or physical stores for the business owner 208 to conduct commercial activities. In another example, the service provider 206 described herein may provide services, such as on-demand services include adjusting its physical store upfront, themes, styles, or layouts, in response to the request from the business owner 208.

In one example, the database server 112 may include at least a map server 204, a content presenting server 202, and a datacenter 214. The map server 204, the content presenting server 202, and the datacenter 214 are in electrical communication through internet or intranet as needed. A client 208, such as a customer, a consumer, an end user and the like, may access and interact with the database server 112 through one or more of the computing devices 100 (shown as 100a, 100b, 100c, 100d in FIG. 2). The computing device 100 that may be utilized to be in communication with the data base server 112 may be a desktop computer 100a, a laptop 100b, a portable device 100c, such as the example depicted in FIG. 1, or a tablet 100d, or other suitable devices that may perform computational operations. It is noted that service provider 206, the business owners 208, the map managers 210 and the developers 212, or other entities may access the data base server 112 using any kind of the computing devices 100 shown or not shown in FIG. 2. In one example, the map server 204 and the content presenting server 202 in the database servers 112 are in communication with the datacenter 214. The processor 167 may be utilized in the database servers 112 configured to execute command and instructions from the datacenter 214 and/or the memory 165.

In one example, the service provider 206 may upload, post, submit, or request a business content, such as an advertisement or other commercial information, via an interaction with the content presenting server 202. The service provider 206 may connect to the content presenting server 202 through the network 110. The service provider 206 may first register in the dynamic platform 200 as a “service provider,” a “property provider,” an “advertiser,” or the like, to allow posting or submitting contents in the dynamic platform 200. It is noted that the content presenting server 202 referred herein could be any types of the servers as needed. In one example, the contents input in the content presenting server 202 may be advertising content, business content, service content, product content, or other content items. Such content input may be in the form of graphical presentations, text, images, audio, video, or combinations of one of more of any of forgoing, etc. The contents may also include embedded information, such as links, meta-information, and/or machine executable instructions. The contents can be formatted by a map server 204 for presentation in a digital map. The contents can be stored in the datacenter 214 where both the content presenting server 202 and the map server 204 may retrieve the contents as needed. In one embodiment, the service provider 206 may be property owners, landlords, real estate agents, intermediate agents, property developers, space owners, interior designers or the like that have a physical storefront, such as a brick-and-mortar store or restaurant, for rent or lease.

In some examples, the developers 212, such as real estate property development agencies or companies, and map managers 210, such as map service providers, may access the map server 204 and update the data, such as physical structures, buildings, inventories and the like, in the map server 204 as needed. Generally, the developers 212 and the map managers 210 often have the most up-to-date geographic changes, data, floorplans, zoning information in a local area. Thus, the developers 212 and the map managers 210 may be authorized by the dynamic platform 200 to access the map server 204 to update the existing data with the updated information in the map server 204. The update information of the most up-to-date geographic information may then be output in the digital map. Such updated geographic information and changes in a local area may then be saved in the datacenter 214 as needed. Consequently, the service provider 206 may then upload or post proper contents on the digital map for presentation with the most up-to-date geographic information via the content presenting server 202 to avoid unnecessary information errors due to the outdated information inadvertently listed on the digital map. In some examples, the service provider 206 may also be authorized to make such change. The map server 204 integrates the contents or presentation into the digital map by placing the information indicator from the content presenting server 202 on the digital map.

In some examples, the contents may include information regarding sub-divisions of a physical store or a property based on different ownership, styles, vacancies, or interior layouts of the physical store or the property. For example, when a physical store that has certain floors available for lease but certain floors still occupied, the contents may be formatted by the content presenting server 202 in a manner that allows the map server 204 to specify and present the particular floors for rent/lease in the digital map. In some examples wherein the interior layout of a physical store that allows multiple leases to multiple tenants respectively, the content may also be formatted by the content presenting server 202 to lease a particular room, a particular style, or a particular interior region of the physical store as needed.

Business owners 208, such as vendors, tenants, retail owners, independent sellers, or the like who need a physical storefront or a certain service for business, may then review the presentation of the content in the digital map. The business owners 208 may then access the content presenting server 202 and submit offers for lease or rent of the spaces or properties that best fit the business owner's business request. The service providers 206 may then determine to accept or reject the offers. When an offer from the business owner 208 is accepted by the service provider 206, the business owners 208 may then utilize the physical storefront or the services from the service providers 206 for business, tentatively or permanently, and promote their business by placing a business presentation, a commercial content, commercial update or promotion in the digital map via the map server 204. Such business presentation, commercial content or promotion depicted in the digital map may then be reviewed and browsed by the client 218 who has certain interest or demand for purchasing. In some examples, the business presentation or promotion may be promoted or placed in the digital map by the map managers 210 with or without the request by the business owners 208.

By utilizing the dynamic platform 200, an efficient communication among the service providers 206, developers 212, map managers 210, the business owners 208 and the client 218, such as customers or consumers, may be obtained so that the actual status of the physical stores may be instantly and dynamically presented in the digital map. Furthermore, the dynamic platform 200 may also allow the service providers 206 to adjust their services or products considering the requests from the business owners 208. In some examples, the business owners 208 may send a request to the service provider 206 for change of its product line, services, or physical upfront appearance, themes, styles, or the like. The service provider 206 may then interact with the business owners 208 through the dynamic platform 200 to accommodate the request or need from the business owners 208 to provide on-demand stores. The map server 204 and the content presenting server 202 may format and accommodate such changes and populates the changes in the digital map.

Similarly, the business owners 208 may also flexibly adjust their product lines or services based on the queries or market trends from the clients 218 interacted with the dynamic platform 200. For example, when a physical building is available for rent, the service providers 206, who has the ownership or right of management, may then place a business content on the digital map. Subsequently, the business owners 208 may discover the physical building for business based on the business content presented and decide to rent the physical building. After the ownership or occupancy of the physical building is transferred, the business owner 208 may then promote the new business of the local area in the digital map. Accordingly, the client 218, such as customers or consumers, may also explore the most up-to-date information in the digital map about the dynamic stores or short-term stores opened nearby that fits their purchasing demands. It is noted that the communications among these participants are multi-directional, which means that the service providers 206 may dynamically or flexibly adjust their products or services to fit the business owners' commercial request and the business owners 208 may also flexibly and dynamically change their product lines or service types based on the request from the clients 218 through the dynamic platform 200 as needed.

In some examples, the map managers 210 may also provide computational data, such as statistics, regional/local trending queries, local searches, geographic searches, local directions, navigation data, direction requests, seasonal data, customs, demands, shut-down information, or the like, at a local area to the business owners 208. In one example, the computational data includes user's navigation data, searches or direction requests collected from the selected geographic location in the map. Accordingly, the business owners 208 may base on the trending demand at the local area to open a temporary store that adapts to consumer current demands in the local area. Furthermore, the map managers 210 may also connect the business owners 208 to the service provider 206 who offer on-demand stores/spaces that allow the business owners 208 to have a short-term business plan at the local area for seasonal or flash sales that fit local consumer trends and demand. Thus, the dynamic platform 200 provides multi-directional communications among different parties to enable a quick, instant and efficient communication so as to provide a seamlessly interactive business service or on-demand services that reflects the real market situation in a local area that may satisfy the multiple parties with different business purposes.

In some examples, the business owners 208 may also be also to search or input queries in the digital map based on a specific type of business. For example, when a busines owner desires to search a space for a particular business type with certain business requirements/criteria, the map manager 210, who maintains and populates information in the digital map, may provide suggestion to the business owner 208 with suitable suggestions that fit the business requirements/criteria input from the business owner 208. For example, when the business owner 208 looks for a space for a music studio that requires several small compartments in a building with sound insulation walls, such query may be input in the digital map. After a computational operation, the digital map may then provide relevant spaces or suggestions, within a desired geographic region set by the business owner 208, to the business owner 208 for his/her consideration for business opportunities.

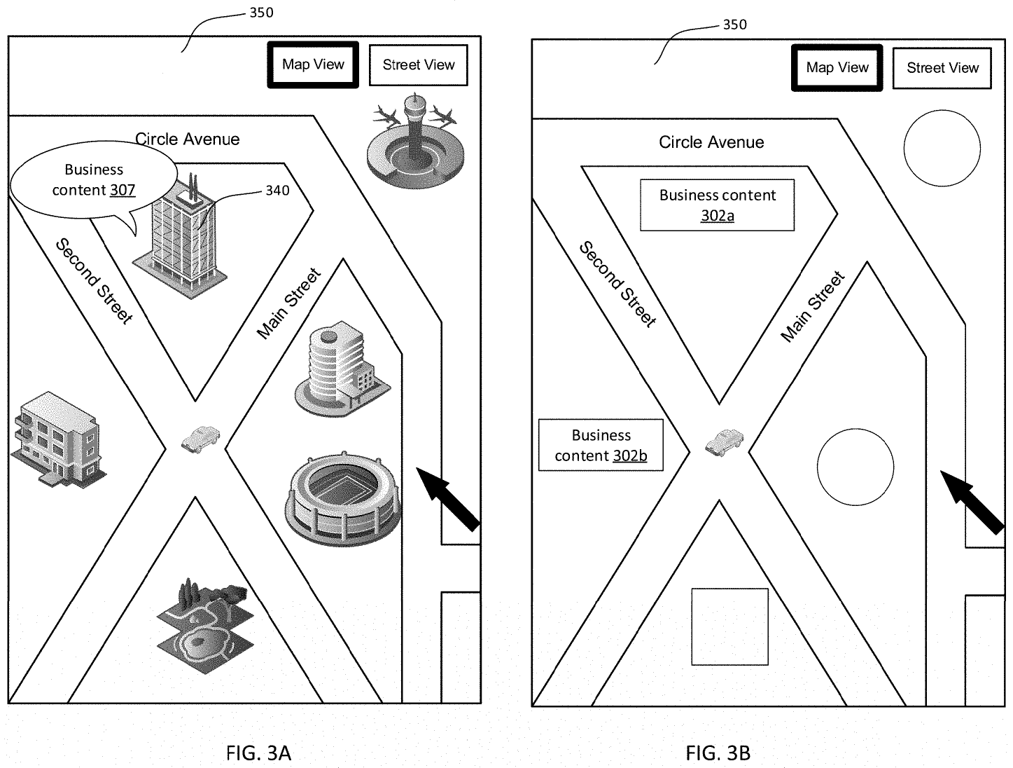

FIG. 3A and 3B depict different examples of a digital map 350 zoomed in at a geographic region of interest with different formats of business contents depicted in the maps 350 in map view respectively. In the example depicted in FIG. 3A, the structures, buildings, infrastructures may be depicted in a three-dimensional view. A business content 307 may be then shown on a building 340, such as a physical store, to indicate a space is available in the building 340 for lease or rent. In the example depicted in FIG. 3B, alternatively, the structures, buildings, infrastructures may be depicted in a two-dimensional view. A business content, shown as 302a, 302b, may then be placed in the digital map 350 to indicate spaces or stores for lease or rent. The business contents 302a, 302b, 307 may be published or posted by the service providers 206 in the content presentation server 202 and the map server 204 may then format the business contents 302a, 302b, 307 to populate and present in the digital map 350 that allows the business owners 208 to explore and interact with the dynamic platform 200.

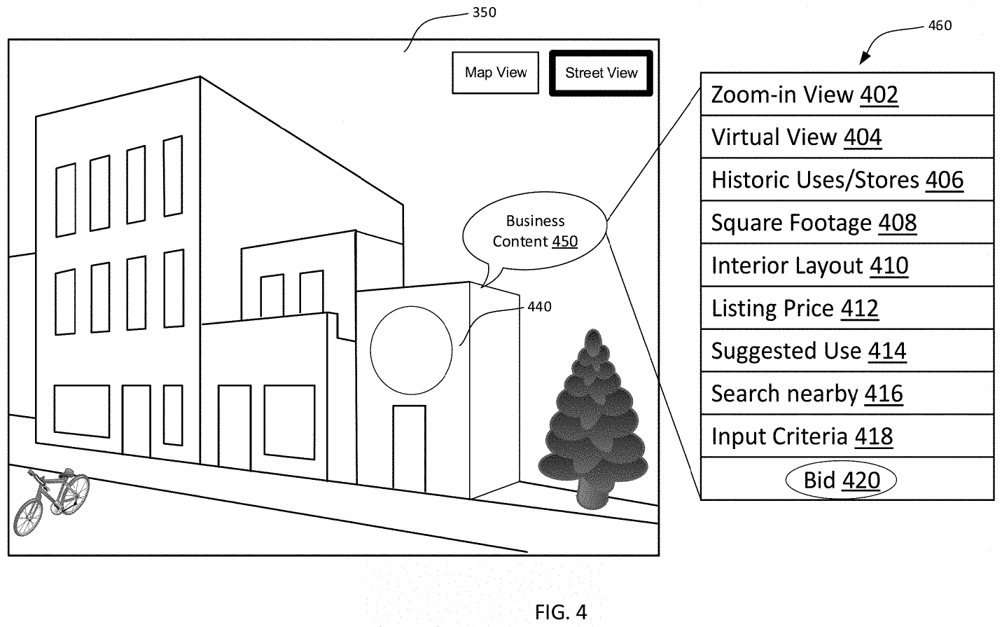

FIG. 4 depict yet another example of the digital map 350 that is depicted in a street view. Similarly, the business content 450 may be shown on a building 440, such as a physical store, to indicate a space available in the building 440 for lease or rent. It is noted that the business content 450, 302a, 302b, 307 are similarly formatted and functionalized that allows the business owners 208 to explore the inventory, property characteristics, designs, layouts or the like of the spaces or stores for rent. The business owners 208 may also be given the options to change or adjust the space or layout provided from the service provider 206 through the dynamic platform 200. In one example, the business content 450 may be further tapped, clicked, or executed to provide a context menu 460. The context menu 460 includes a list of multiple tabs, such as a zoom-in-view tab 402, a virtual view tab 404, a historic uses/historic stores tab 406, a square footage tab 408, an interior layout tab 410, a listing price tab 412, a suggested use tab 414, a search nearby tab 416, an input criteria tab 418 and a bid tab 420. It is noted that the tabs 402, 404, 406, 408, 410, 412, 414, 416, 418, 420 shown in the context menu 460 are only examples and/or frequently used queries that the business owners 208 often utilize. Additional tabs with different query commands or functions may be added to the context menu 460 as needed.

The user may select one or more of the tabs 402, 404, 406, 408, 410, 412, 414, 416, 418, 420 above from the context menu 460 and interact with the map server 204 and the content presentation server 202 to perform the requested functions, which may result in the retrieval of data or additional information from online recourses for display of the additional information.

In one example, the zoom-in view tab 402 may provide additional detailed information, such as dimensions, building appearance, nearby buildings, building styles, or the like, of the building 440. The virtual view tab 404 may provide virtual tour, such as a simulation including a sequence of videos or images, of the structure 440. The virtual tour may utilize multimedia elements, such as sound effects, music, narration, or text to provide the viewer a visual description of the structure 440. In some examples, the virtual tour may include a previously recorded film by the photographer moving continuously from a point to another at a walking pace throughout the subject structure 440.

The historic uses tab 406 may list the recent and past uses of the building 440 for a time period, such as for the past six months or twelve months. The historic uses of the structure 440 may help the business owners obtain a background knowledge of the popular activities or commercial information active in the recent times in the target geographic area.

Furthermore, some details of the building 440, such as the square footage, may be obtained by tapping the square footage tab 408. Additional information, such as year of built, tax information or other associated real estate information, may be integrated or put under the square footage tab 408 or other separate tabs as needed.

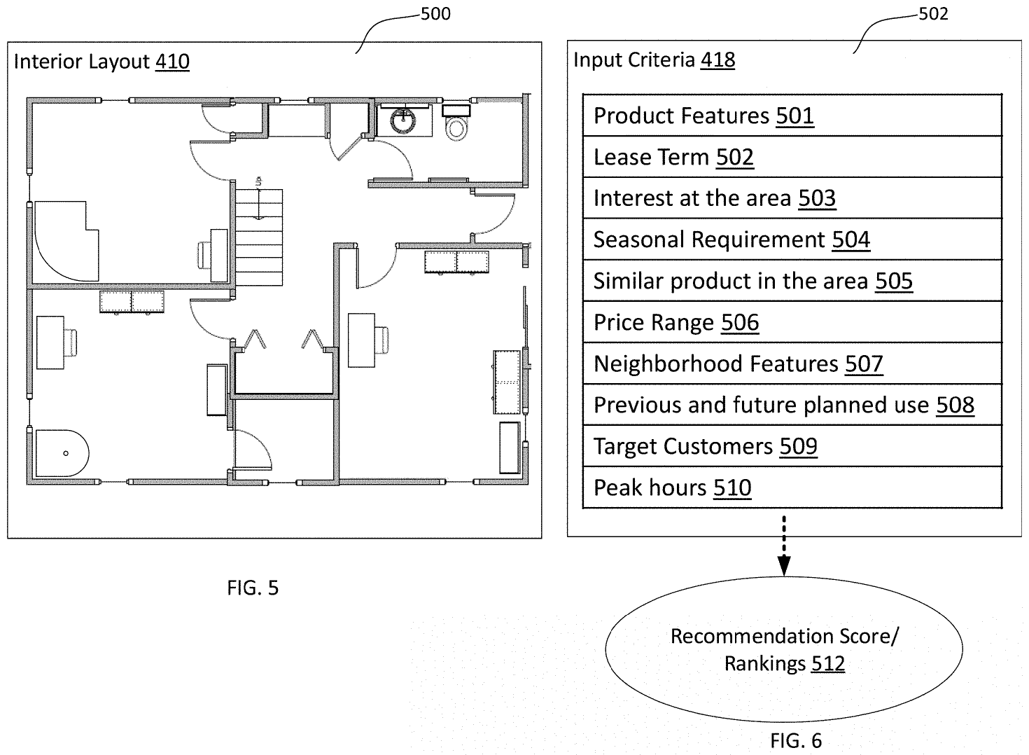

The interior layout tab 410 may be selected to obtain further information regarding the interior layout and/or floorplan of the building 440. For example, when the interior layout tab 410 is selected, the interior layout or called the floorplan 500 of the building 440 is populated in the display screen, as shown in FIG. 5. The interior layout provides information regarding the numbers, styles, designs, color theme, dimensions or other information regarding the rooms comparted inside the building 440. In the situation wherein only certain spaces, such as certain rooms, are available for rent or lease, the interior layout provided from the interior layout tab 410 may help the business owners 208 inspect, review, and evaluate the available spaces within the building 440 prior to placing a bid for the space and/or the room.

The listing price tab 412 may provide the information regarding the price listed for the space, the rooms inside the building 440, or the whole building 440.

The suggested use tab 414 may provide computational data, statistic data, trending queries, local demands, consumer trends, seasonal data, local cultural traits, recent openings or shut-down of commercial activities, or other signals of the local area to the business owners 208. Such signals may help the business owners 208 to make informed business decisions that fit the local market trend. The signals or computational data may be collected so as to provide local market information to the user to business decisions. Just a few examples of such business decisions include when to open a particular type of store or offer a particular product line or revise menu offerings, what types of products or businesses are needed or desired in particular neighborhoods, a status of nearby businesses, etc. For example, when a business owner searches for and plans to open a sport shop in a local area, the suggested use tab 414 may provide information to the business owner 208 that, by statistic, a spring opening in time for summer is a good option for sport related stores while the fall season in time for holidays might be a better option for jewelry stores. In another example, when the map application receives a number of searches about clothing stores in the area at certain seasons, it may indicate the demand or interest for clothing stores in the selected geographic area at a particular timeline of the year. The suggested use tab 414 may provide such information to the business owners 208 for their consideration. In yet another example, when a large book shop closes its business in an area, nearby book retailers may be provided with the opportunity to carry and sell the books or products for clearance from the large book shop as needed. Other related computations, statistics, or calculations may also be employed to provide relevant local market information or indication to the business owners 208 for business decision making

The search nearby tab 416 may further provide the business owners 208 an option to search for relevant business activities in the area that may likely enhance or promote, diminish or discourage the business opportunities. For example, a hot chocolate drink shop may be suggested to open during a winter hockey season located nearby ice rinks or pond rinks so as to have a relatively high probability of business success. The neighborhood features, lack of hot drink shops in winter hockey season, may be provided to the business owners 208 for consideration as needed.

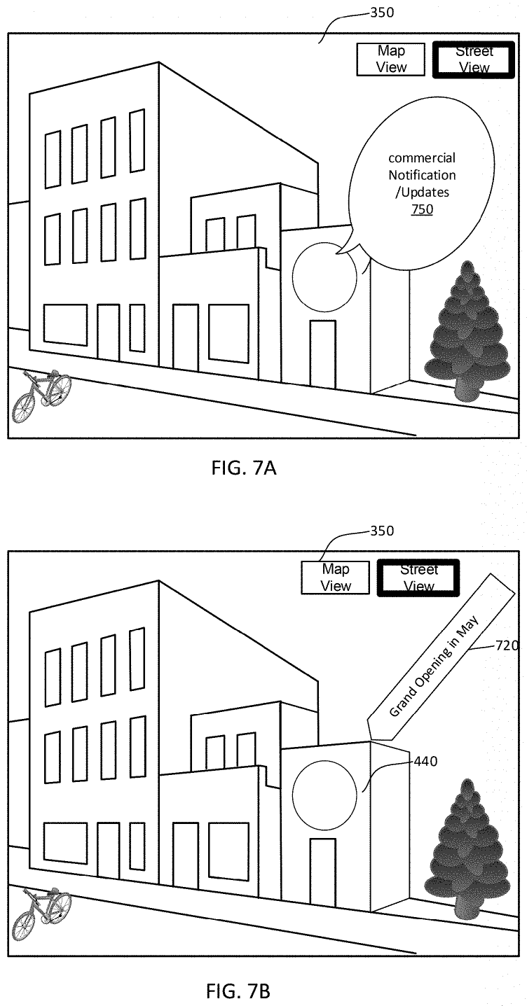

Furthermore, an input criteria tab 418 may be further provided in the context menu 460 that allows the business owners 208 to formulate their queries. The input criteria tab 418 may further provide a drop-down list 502, as shown in FIG. 6, that, when selected, allows the business owners 208 to input queries that fit their own business interest. It is noted that the criteria shown in the drop-down list 502 is only for example purposes. Additional or different search tabs may be included in the drop-down list 502 as needed.

In one example, the tabs 501, 502, 503, 504, 505, 506, 507, 508, 509, 510 provided in the drop-down list 502 of FIG. 6, may include product features, lease term, interest/demand at the area, seasonal requirements, similar product in the area, price range, neighborhood features, previous and further planned use, target customers or peak hours for business and the like. The tabs 501, 502, 503, 504, 505, 506, 507, 508, 509, 510 provided in the drop-down list 502 may be programmed in a model that utilizes a machine learning technique. The machine learning technique may help the model learn and evolve from the search results, computational data or statistic data received or input from the big data from the datacenter 214. The machine leaning technique helps build a learned ranking model to help the business owners 208 make business decision that fits the market trend, thus improving the business likelihood of being successful. Such learned ranking model may integrate the information as obtained, such as product features, business natures, neighborhood features, online searches in the area, related store features, previous stores, planned stores or the like, and output a recommendation score or ranking 512 to the business owners to suggest how suitable this location is for the certain type of the business that the business owners are looking for. For example, a recommendation score 512 greater than a predetermined threshold may be considered encouragement for the business owner 208 to move forward with the decision and place a bid, utilizing the bid tab 420, as depicted in FIG. 4, to rent and lease the space for business. When the bid is placed and the offer is accepted, the service provider 206 may determine to accept or turn down the offer. When accepted, the transaction may be completed by both parties in the dynamic platform 200. Thus, the business content 450 shown in the digital map may be altered and adjusted to commercial promotions or notifications. In contrast, a recommendation score 512 less than the predetermined threshold may be considered discouragement for the business owner 208, suggesting the business owner 208 to seek other opportunities for business. Thus, another search is suggested to find another space, another opening time, another product types or other different factors/features to increase the likelihood of success of the business. In some examples, the service provider 206 may adjust its service types, layouts, or property characteristics to fit the requirements from the business owner 208.

Furthermore, as the dynamic platform is built based on the constant communication between the map server 204 and the content presentation server 202, the business owner 208 may also receive suggestions about the lack of certain business in the area based on the navigation data, searches or direction requests from the users, such as the local consumers. For example, the navigation data, searches or direction requests from the map server 204 indicates that consumers in the area often travel a long distance for a pharmacy store in winter months, this may suggest a business opportunity for opening a short-term pharmacy store during the particular winter months for the local seasonal demand. Thus, by collecting the computational data of local market based on the navigation data from users, a more accurate location market information may be obtained.

Thus, the context menu 460 and the drop-down list 502 may generally provide the business owners 208 with the dynamic information in the local area. In one example, as described above, the local market information comprises neighborhood features, statistic data, trending queries, local supply and demands consumer trend, market trend, seasonal data, local cultural traits, recent openings or shut-down of commercial activities, and past and future uses of the stores or other related information as needed.

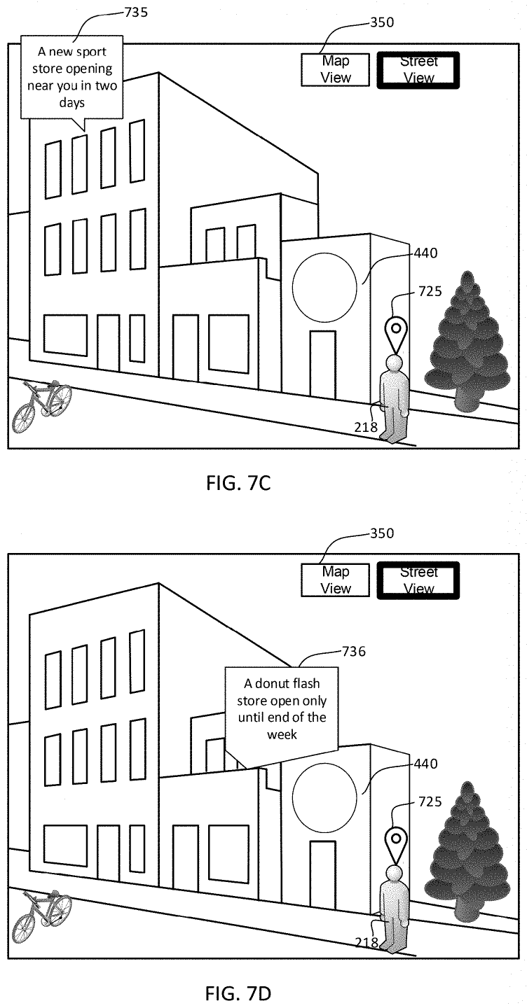

FIG. 7A-7D illustrate examples of commercial notifications or updates 750 populated in the digital map 350. As discussed above, when the offer is accepted and the transaction is completed via the dynamic platform 200, the business content 450 posted on the building 440 from FIG. 4 may then be adjusted and replaced with a commercial notifications or updates 750, as shown in FIG. 7A. The commercial notifications or updates 750 may be edited, published, posted, released, or listed by the business owner 208 of the winning bid of the business content 450. The business owner 208 may decide to post the commercial notifications or updates 750 in different formats so as to attract the users 218, such as consumers or customers, to visit the building 440 for commercial activities. In some examples, the map managers 210, upon notifying by the dynamic platform 200 about the completed transaction, may assist publishing the commercial notifications or updates 750 in the digital map 350 to notify the clients 218, such as consumers or customers, for the new business activity in the building 440 where the transaction is completed and the ownership of the building 440 is tentatively or permanently transferred. In some examples, the commercial notifications or updates 750 may be automatically populated and the information in the digital map is automatically updated by the dynamic platform 200 once the transaction is completed.

In some examples, the commercial notifications or updates 750 may also include different types of the services, such as change of the items, menus, or themes in a restaurant or store upfronts, updated in the selected geographic region. For example, when a menu in a restaurant is updated, the updated menu may be posted, published or listed in the digital map, such as posting as the commercial notifications or updates 750 depicted in FIG. 7A so that the clients can easily be notified or reminded regarding the change in service of the restaurant or the business in the selected geographic location in the digital map.

In some examples, the commercial notifications or updates 750 may be selected to further provide additional information, such as merchandise types, business features, price range, product or service information, discount information, historical uses of the building or the like, so as to allow the clients 218 to understand the past, present, or even future business activities in the building 440. In this example, the commercial notifications or updates 750 servers as product or service introduction that allows the consumers or customers to understand the nature of the business.

FIG. 7B depicts another format of the commercial notifications or updates 720 that the business owner 208 or the map manager 210 may populate in the digital map 350. In this example, the commercial notifications or updates 720 serves as notification and/or commercial updates that include a textual description of “Grand Opening in May” for business promotion so that the users' attention may be easily captured when the digital map 350 is launched at the computing device 100 carried by the users 218. In some examples, a graphic expression may be utilized in the commercial notifications or updates 720 as needed to capture the visual attention of the users 218 and then further urge the purchasing motive of the users 218.

FIG. 7C depicts yet another format of the commercial notifications or updates 735 appeared in the digital map 350 based on the location of the client 218 who is in close proximity to the business activities. For example, when the client 218 launches the map application and the digital map 350 is populated on the display screen of the computing device 100, an automatic detection of the location of the client 218 carrying the computing device 100 may be performed so as to set a marker 725 in the digital map 350, indicating location of the client 218. After the location of the client 218 is detected and the marker 725 is set, active commercial notifications or updates 735 within a predetermined range, such as 5 mile radius from the marker 725 or the like, may be automatically populated so as to help the business owner 208 to promote the businesses active in the local area. In the example depicted in FIG. 7C, a future business activity is depicted in the commercial notifications or updates 735, shown as “A New Sport Store Opening Near You In Two Days”, so as to notify the client 218 about the time line of a near future event to be occurred in the neighborhood.

FIG. 7D depicts still another format of the commercial notifications or updates 736 appeared in the digital map 350 based on the location of the client 218 who is in close proximity to the business activities. Instead of a future event of the commercial notifications or updates 735, the commercial notifications or updates 736 provides a currently active business event, such as “A Donut Flash Store Open Only Until End Of The Week” depicted in FIG. 7D, in the nearby area in close proximity to the client 218. Thus, when the client 218 interacts with the digital map 350, the commercial notifications or updates 736 may be instantly populated in the digital map 315 so as to notify the client 218 about the current business activity and/or sale in the neighborhood. Thus, the client 218 may determine whether to involve with the active business based on his/her personal preference or need.

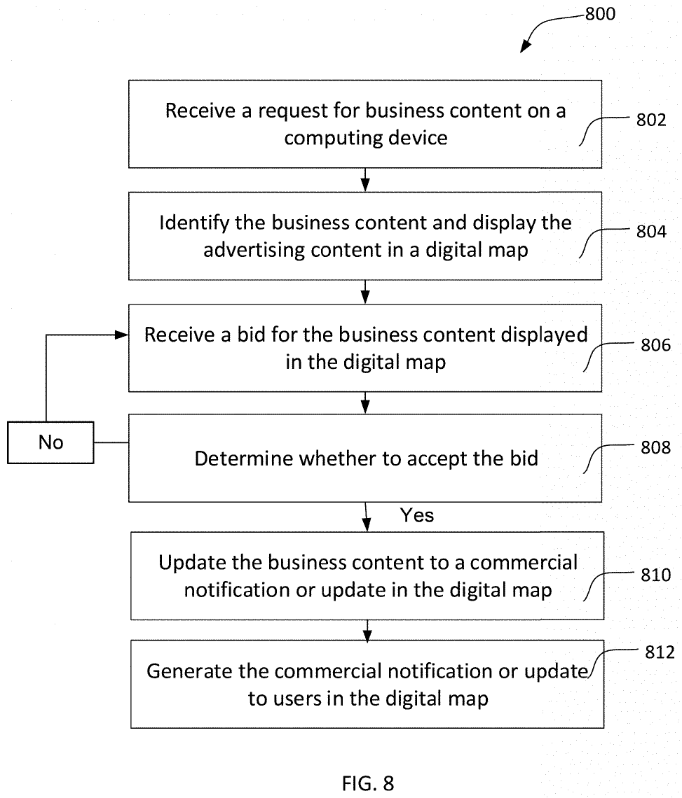

FIG. 8 depicts a flow-diagram illustrating an example method 800 of performing communications of business activities in the dynamic platform 200 of FIG. 2 according to aspects of the disclosure. Such methods may be performed by operations among multiple parties utilizing multiple computing devices, such as the computing device 100a, 100b, 100c, 100d described above, modifications thereof, or any of a variety of other computing devices having different configurations. It should be understood that the operations involved in the following methods need not be performed in the precise order described. Rather, various operations may be handled in a different order or simultaneously, and operations may be added or omitted.

In block 802, a request for business content may be received by the content presentation server 202 in the dynamic platform 200. The request for business content may be initiated by the service provider 206, the developer 212 or the map manager 210 who has a space, a building, a store, or the like for rent or lease. The business content may include dynamic information on physical spaces occupied or available for occupancy. The service provider 206, the developer 212 or the map manager 210 may utilize a computing device, such as the computing device 100a, 100b, 100c, 100d described above to input the request to the content presentation server 202 in the dynamic platform 200.

In block 804, once the request of the business content is received, the request may be identified, processed, and formatted to be populated as business content in the digital map by the map server 204.

In block 806, upon viewing by the business owner 208 who needs a space for business activities, the business owner 208 may put a bid and make an offer in response to the business content in an attempt to rent or lease the space, given that the space provides satisfying conditions/factors for the business requirements from the business owner 208. The bid may be processed by the content presentation server 202 in the dynamic platform 200.

In block 808, the bid may then be reviewed by the service provider 206. When the bid is taken and the offer is accepted, the process may be moved on to block 810 for further operations. In contrast, when the service provider 206 decides to turn down or reject the offer, the operation may be looped back to block 806 to await an acceptable offer.

In block 810, once the offer is accepted, the transaction may be completed by the parties involved, and the ownership or right of management or occupancy of the space may be tentatively or permanently transferred to the business owner 208. Accordingly, the business content may then be adjusted or altered and the business owner 208 may replace it with a commercial promotions or notifications in the digital map that may promote the new business activities in the space.

In block 812, once the commercial promotion or notification is presented in the digital map, the new commercial information or updates may be delivered or sent to the clients 218 for business promotion. The clients 218 may be notified by an interaction with the digital map populated in the computing device, or by notifications sent to the computing device provided from the dynamic platform.

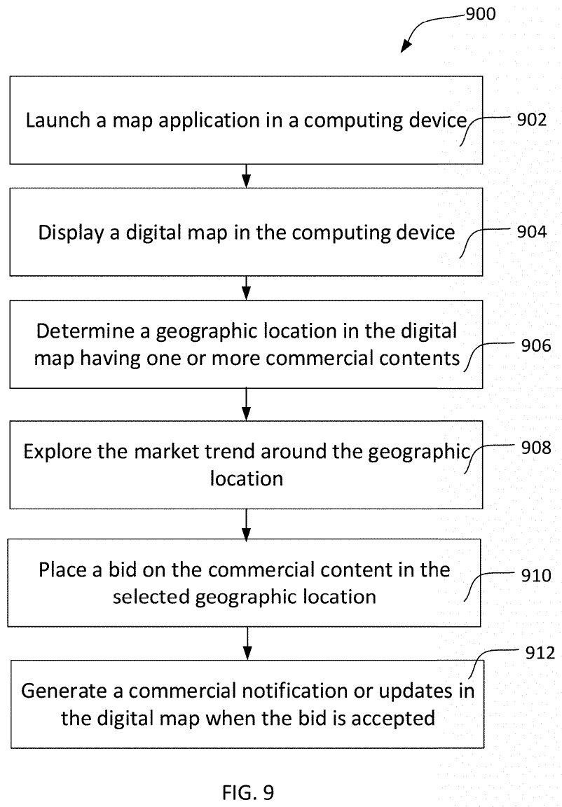

FIG. 9 depicts a flow-diagram illustrating an example method 900 of performing communications of business activities by the business owner 208 utilizing the dynamic platform 200 of FIG. 2 according to aspects of the disclosure. Such methods may be performed by utilizing multiple computing devices, such as the computing device 100a, 100b, 100c, 100d described above, modifications thereof, or any of a variety of other computing devices having different configurations. It should be understood that the operations involved in the following methods need not be performed in the precise order described. Rather, various operations may be handled in a different order or simultaneously, and operations may be added or omitted.

In block 902, a map application may be launched by a user, such as the business owner 208 in this example, actively interacting with a computing device, such as the computing device 100 depicted in FIG. 1.

In block 904, after the map application is launched, a digital map is then shown and depicted on a display screen of the computing device. In the meantime, the dynamic platform may be provided in the digital map.

In block 906, after the map application is launched, the user, such as the business owner 208, may start to navigate the digital map and determine a selected geographic area for his/her business. The business owner may explore or study one or more business contents listed in the selected geographic area for business opportunities that fit his/her product features or service categories.

In block 908, when the selected geographic area is determined in the digital map, the user may utilize the dynamic platform to review the market trend and related information in the selected geographic area. For example, the user may search for the trending queries in the area to understand the local supply and demand situation so as to determine if the location is a good fit for the business opportunity. The user may utilize the input criteria tab 418 depicted in FIGS. 4 and 6 to obtain the most up-to-date information about the business activities in the nearby neighborhood, real estate details, and related information. The most up-to-date information may become factors in his/her business decision making process. Furthermore, the user may also interact with the dynamic platform by tapping the suggested use tab 414 in FIG. 4 to obtain information, such as suggested timelines, seasons, interior design, styles, square footage, and the like, for different business categories. After the necessary information is gathered, the user may be determined whether to place a bid and make an offer for the business content in the selected geographic area. In some examples, the user may send a request to the service provider to inquiry if the service provider may alter or accommodate its space for the specific requirements or business needs from the user by the communications conducted through the dynamic platform. Alternatively, the digital map provided from the dynamic platform may also accommodate the need, either from the service provides or the users, to present their inventory, product lines, spaces, or the like, in a manner that the clients, such as customers and consumers, may easily view and recognize the types of services provided for increase of the business opportunities.

In block 910, the user may place a bid to make an offer on the business content in the selected geographic area when the user determines that the space as provided is a good fit for the business opportunity. After the offer is accepted and the transaction is completed by the participants involved, the ownership or right of management/occupancy of the space may be temporarily or permanently transfer to the user for his/her use.

In block 912, after the offer is accepted and the transaction is completed, the business content may be removed, and a commercial promotion or notification may be published instead. The commercial promotion or notification may be automatically populated once the transaction is completed by the map manager and saved in the datacenter 214. Alternatively, the user may be authorized to edit, post, or publish the commercial promotion or notification in his/her preferred manner. The commercial promotion or notification may be information about the new business that will be operated in the space and promotions in the selected geographic area. In some examples, the commercial promotion or notification may commence displaying on the digital map for promotion prior to the physical storefront, such as the brick-and-mortar store, is ready for commercial activities.

Thus, present disclosure provides methods and apparatus of a dynamic platform utilizing an interactive digital map that allows users, customers, consumers, advertisers, business owners, vendors, property managers and the like to explore and discover various types goods at a selected geographic region of interest. The dynamic platform may provide an interactive interface that allows communications among the users, customers, advertisers, business owners, vendors, property managers and the like to perform business activities that better fits their business interest. The dynamic platform may also provide statistic data, market trend, past and future uses of the stores in the target area, and the like, to allow the users to discover the most up-to-date business activities or services in an area of interest. The dynamic platform also allows efficient communication among the service providers, the business owners and consumers so that services or production lines may be adjusted or changed in response to the local supply and demand. Accordingly, the dynamic platform may provide dynamic business information at a geographic region of interest to allow participants from different sides to explore the business opportunities and expose their product in an efficient manner that meets the market needs and the local supply and demand.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method, comprising:
providing, by one or more processors, a map for display on a computing device;
receiving, by the one or more processors, a request for displaying a business content in the map, wherein the business content comprises information in relation to physical stores available for business activities;
displaying, by the one or more processors, the business content at a selected geographic location in the map;
collecting, by the one or more processors, computational data of local market information related to the selected geographic location;
presenting, by the one or more processors, the local market information in the map; and
providing, by the one or more processors, a recommendation whether to update the business content based on the local market information.

2. The method of claim 1, further comprising:
receiving, by the one or more processors, a bid in response to the recommendation.

3. The method of claim 2, further comprising:
accepting, by the one or more processors, the bid; and
updating, by the one or more processors, the business content in the selected geographic location in the digital map.

4. The method of claim 1, wherein collecting, by the one or more processors, the computational data of the local market information related to the selected geographic location further comprises:
utilizing a machine learning technique to provide dynamic information related to the location market information.

5. The method of claim 1, collecting, by the one or more processors, the computational data of the local market information related to the selected geographic location further comprises:
utilizing a learned ranking model to integrate the computational data to provide the location market information related to the selected geographic location.

6. The method of claim 5, further comprising:
outputting a recommendation score by the learned ranking model.

7. The method of claim 6, wherein the recommendation score suggests whether to place a bid in response to the business content.

8. The method of claim 1, wherein the computational data comprises user's navigation data, searches or direction requests collected from the selected geographic location in the map.

9. The method of claim 3, wherein updating, by the one or more processors, the business content in the selected geographic location in the digital map further comprises:
generating, by the one or more processors, commercial update or notifications in the digital map.

10. The method of claim 1, wherein the business content comprises an interior layout, a style, an ownership change of a space in the target geographic location.

11. The method of claim 6, wherein the business content is listed by a property provider.

12. A computing device, comprising:
one or more memories:
one or more processors in communication with the one or more memories, the one or more processors configured to:
provide, by one or more processors, a map for display on a computing device;
receive, by the one or more processors, a request for displaying a business content in the map, wherein the business content comprises information in relation to physical stores available for business activities;
display, by the one or more processors, the business content at a selected geographic location in the map;
collect, by the one or more processors, computational data of local market information related to the selected geographic location;
present, by the one or more processors, the local market information in the map; and
provide, by the one or more processors, a recommendation whether to update the business content based on the local market information

13. The computing device of claim 12, further comprising:
place, by the one or more processors, a bid in response to the recommendation in the map.

14. The computing device of claim 13, further comprising:
accept, by the one or more processors, the bid; and
update, by the one or more processors, the business content in the selected geographic location.

15. The computing device claim 12, wherein a machine learning technique is utilized to provide dynamic information related to the location market information

16. The computing device claim 12, wherein a learned ranking model is utilized to integrate the computational data to provide the location market information related to the selected geographic location.

17. The computing device of claim 16, wherein the learned ranking model outputs a recommendation score.

18. The computing device of claim 17, wherein the recommendation score suggests whether to place a bid in response to the business content.

19. A computer-readable storage medium comprising executable computer instructions for performing operations comprising:
receiving a business content from a service provider in a dynamic platform in a map provided by a computing device, wherein the business content comprises information in relation to physical stores available for business activities;
displaying the business content at a selected geographic location in the digital map in the computing device;
inputting queries by a user; and
interactively adjusting the business content by the service provider based on the queries input by the user.

20. The computer-readable storage medium of claim 19, further comprising:
outputting a recommendation score to the user based on the queries provided by the user.
